(19) United States
(12) Patent Application Publication
(10) Pub. No.: US 2026/0185673 A1
(43) Pub. Date: Jul. 2, 2026

(54) LIGHTING DEVICE FOR A MOTOR VEHICLE, COMPRISING AT LEAST ONE DIAPHRAGM

(71) Applicant: VALEO VISION, Bobigny (FR)

(72) Inventor: Yves GROMFELD, Bobigny (FR)

(73) Assignee: VALEO VISION, Bobigny (FR)

(21) Appl. No.: 18/857,612

(22) PCT Filed: Apr. 19, 2023
(86) PCT No.: PCT/EP2023/060174

§ 371 Date: Oct. 17, 2024

(30) Foreign Application Priority Data
Apr. 20, 2022 (FR) 2203640

(51) Int. Cl. F21S 41/20; F21S 41/148; F21S 41/26; F21S 41/32; F21S 41/33; F21S 41/365; F21S 41/43

(52) U.S. Cl. CPC F21S 41/285; F21S 41/148; F21S 41/26; F21S 41/322; F21S 41/337; F21S 41/365; F21S 41/43

(57) ABSTRACT

The invention relates to a luminous device of an automotive vehicle, including at least one luminous module. The luminous module includes a plurality of light sources able to emit light and at least one collector with a reflective surface arranged to collect and reflect the light emitted by the plurality of light sources into a light beam. A lens associated with the luminous module, arranged to project the light beam reflected by the collector. The lens being arranged to form on the road an image of the reflective surface of the collector. At least one transparent or translucent diaphragm having an incidence face capable of receiving part of the light beam reflected by the collector of the luminous module and arranged to refract the received part in a direction deviating from the lens.

### TECHNICAL FIELD

The invention relates to the technical field of luminous devices for vehicles. It is particularly, but non-limitingly, applicable to automotive vehicles.

### BACKGROUND OF THE INVENTION

In the field of automotive vehicles, it is generally known practice to use luminous devices comprising a plurality of luminous modules each comprising a light source and a collector with a reflective surface, the device comprising an optical projecting system of lens type common to the plurality of luminous modules, the common lens imaging each of the reflective surfaces of the collectors to form a light beam having an upper cutoff.

The lens introduces geometric aberrations into the light beams, causing distortion of the vertical cutoff of the light beams, these aberrations being compensated for through use of opaque diaphragms placed on either side of the light beam, between the collectors and the lens. However, these opaque diaphragms create dark zones in the luminous device when it is observed from the outside, negatively impacting its visual appearance.

The invention therefore has this context and seeks to solve all the aforementioned drawbacks. Thus, the invention seeks to provide a luminous device in which geometric aberrations are limited while allowing a lens having a uniform illuminated appearance and compact dimensions to be obtained.

### SUMMARY OF THE INVENTION

The invention relates to a luminous device of an automotive vehicle, comprising at least one luminous module, the or each luminous module comprising a plurality of first light sources able to emit light and at least one collector comprising a reflective surface arranged to collect and reflect the light emitted by said first light sources into a light beam; a lens associated with said luminous module, arranged to project the light beam reflected by the collector of said luminous module, said lens being arranged to form on the road an image of the reflective surface of the collector of said luminous module; at least one transparent or translucent diaphragm having an incidence face capable of receiving part of said light beam reflected by the collector of said luminous module and arranged to refract said received part in a direction deviating from said lens.

The transparent or translucent diaphragm is able to allow the light beam to pass through said diaphragm. The diaphragm may thus be placed between the collector and the lens, along an optical path of the light beam. The diaphragm may be placed so that part of the light beam reflected by the collector is able to reach the incidence face and so that the incidence face is able to refract said part of the beam toward a direction away from the lens. Thus, the aberrations formed in the light beam resulting from projection of the part of the light beam by the lens are removed by virtue of deflection of said part of the light beam by the incidence face of the collector.

In addition, since the diaphragm is transparent or translucent, it improves the visual appearance of the luminous device.

Advantageously, each first light source is able to emit an elementary light beam, and the collector comprises a plurality of portions, the reflective surface of each portion being arranged to reflect one of the elementary light beams in an elementary reflection direction passing through the lens, a portion, called the stray portion, of at least one of the elementary light beams being capable of reaching a lateral end zone of the lens.

Advantageously, said incidence surface of the diaphragm is arranged to intercept said stray portion so as to refract it in a refraction direction deviating laterally from the elementary reflection direction and from said lateral end zone of the lens.

Each collector may comprise twelve portions, thus the luminous module may comprise twelve first light sources. The lens may be a single lens and be associated with the collector comprising the twelve portions.

Advantageously, the lens is arranged to project the elementary light beam reflected by one or each of the portions of the collector and the lens is arranged to form on the road an image of the reflective surface of this or each portion of the collector.

Where appropriate, the lens may have a focal plane; the lens may for example be a cylindrical lens, and the lens may be arranged so that this focal plane passes through an edge of each of the portions of the collector, and in particular a rear edge of these portions of the collector. What is in particular meant by the fact that the focal plane passes through a rear edge of the portions of the collector is that the focal plane is located at a distance of less than 10 mm from the rear edge of the portions of the collector. Therefore, the lens may form a luminous segment from the elementary light beam, said luminous segment possibly comprising vertical cutoffs, and preferably an upper horizontal cutoff. All of the elementary light beams reflected by the collector together form the reflected beam.

The stray portion of one of the elementary light beams comprises stray light rays capable of being projected by the lateral end zone of the lens, outside of the luminous segment formed by the lens from the elementary light beam, and bounded by the vertical cutoffs. The stray light rays may lie on either side of the lens, and hence they are capable of being projected by each lateral end zone of the lens.

The lateral end zones of the lens may be vertical in a position of the lens. In another embodiment, the lens may be rotated so that t e lateral end zones of the lens may be horizontal.

The luminous module may have an optical axis defined by the overall direction of projection of the light beam by the lens. The incidence face of the diaphragm may be arranged to refract said stray portion in a refraction direction deviating from the elementary reflection direction with respect to the optical axis.

Advantageously, the diaphragm comprises a deflection face facing the incidence face and arranged to deflect said stray portion refracted by the incidence face in a deflection direction deviating more from the elementary reflection direction than the refraction direction.

The angle made tween the of tical axis and the elementary reflection direction may be smaller than the angle made between the optical axis and the refraction direction, which may itself be smaller than the angle made between the optical axis and the deflection direction.

The incidence face and the deflection face may form a prism, said prism in particular possibly defining a distal portion of the diaphragm.

Advantageously, the incidence face and deflection face are arranged so that said refracted stray portion is refracted or reflected by the deflection face.

The refracted stray portion may be deflected in front of the prism. The stray portion may be deflected behind the prism.

Advantageously, the diaphragm has an inner lateral surface comprising said incidence face and extending from a lateral edge of the collector to said incidence face, the incidence face making an angle to the rest of the inner lateral surface.

The inner lateral surface may form an inner side of the diaphragm, said inner lateral surface possibly being oriented toward the interior of the luminous module. The lateral surface may or may not be beside a lateral edge of the collector.

The incidence face of the diaphragm may make a salient angle, i.e. an angle between 0 and 180°, to the rest of the inner lateral surface. The incidence face of the diaphragm may make a re-entrant angle, i.e. an angle between 18° and 360°, use of an incidence face making a re-entrant angle possibly allowing total internal refraction of the non-stray portion of the beam off the lateral surface to be avoided.

Advantageously, the luminous module comprises an absorber arranged to absorb said refracted stray portion.

The absorber may be configured to absorb the deviated stray portion. The absorber may be configured to absorb the reflected stray portion. The absorber may be configured to absorb the re-refracted stray portion.

Advantageously, the diaphragm has an outer lateral surface opposite the inner lateral surface, said absorber being arranged plumb with the outer lateral surface.

The outer lateral surface may form an outer side of the diaphragm, said outer lateral surface possibly being oriented toward the exterior of the luminous module.

The inner lateral surface and the outer lateral surface may be connected to each other by the deflection face. The deflection face may thus form a distal lateral surface of the diaphragm. The outer lateral surface and inner lateral surface, with the exception of the incidence face of said inner lateral surface, may be substantially parallel to each other.

The lateral surface of the diaphragm may be planar, the absorber thus being able to be placed in the vicinity of this planar surface. For example, an air gap will possibly be provided between the planar surface and the absorber.

Advantageously, the luminous module comprises two transparent or translucent diaphragms, arranged on either side of the collector and each having an incidence face capable of receiving part of said light beam reflected by the collector of said luminous module and arranged to refract said received part in a direction deviating from said lens.

The two diaphragms may be symmetrical. For example, both diaphragms may comprise an incidence face making a salient angle. Also for example, both diaphragms may comprise an incidence face making a re-entrant angle.

In another embodiment, the two diaphragms may be asymmetrical. For example, one of the diaphragms may comprise an incidence face making a salient angle and the other of the diaphragms may comprise an incidence face making a re-entrant angle.

The two diaphragms are placed so that the part of the light beam received by the incidence face of one of the diaphragms can deviate in a direction opposite to the direction of the part of the light beam received by the incidence face of the other of the diaphragms.

Advantageously, the luminous module comprises a second light source positioned facing an entrance face of said diaphragm and able to emit light into said diaphragm, the diaphragm being arranged so that said light emitted by the second light source propagates, by total internal reflection off the internal walls of the diaphragm, to an exit face of said diaphragm, which exit face is arranged facing said lens of the luminous module.

The luminous device comprises a control unit able to selectively activate the first light sources, for example in response to an instruction to emit a given light beam received by the control unit. The control unit may for example activate all of the plurality of first light sources or only some of the plurality of first light sources.

The control unit of the luminous device may be arranged to simultaneously activate the second light source with one, a plurality or each of the first light sources. The control unit of the luminous device may be arranged to control the second light source so that it emits light with a lower intensity than the first light sources.

The luminous module may comprise a third light source so that the second light source may be positioned facing the entrance face of one of the diaphragms and so that said third light source may be positioned facing the entrance face of the other of the diaphragms. The control unit of the luminous device may be arranged to simultaneously activate the third light source with the first light sources. The control unit of the luminous device may be arranged to simultaneously activate the third light source with the second light source. The third light source may emit light with a lower intensity than the first light sources and thus have an intensity similar to that of the second light source.

The exit face of the diaphragm arranged opposite said lens may coincide with the deflection face.

Advantageously, the diaphragm has a lower surface comprising said entrance face and an upper surface having a coupling face arranged to deflect and couple said light emitted by the second light source into the diaphragm.

The upper surface and lower surface, with the exception of the entrance face and the coupling face, may be substantially parallel to each other.

The coupling face of the upper surface may have a parabolic profile focused on the second light source or on an entrance point of the entrance face of the diaphragm. In another embodiment, the coupling face of the upper surface may have an elliptical profile.

Advantageously, the plurality of first light sources and the second light source are mounted on the same carrier. Where appropriate, the third light source may also be mounted on the same carrier.

The carrier may be the same printed circuit board. Said printed circuit board may also comprise the collector and the two diaphragms. The control unit may be mounted on said printed circuit board.

### BRIEF DESCRIPTION OF THE FIGURES

Further advantages and features of the present invention will now be described using examples that are purely illustrative and by no means limit the scope of the invention, and on the basis of the appended drawings, in which the various figures show;

FIG. 1 schematically shows a perspective view of a luminous device according to one embodiment of the invention.

FIG. 2 schematically shows a view from above of a luminous device according to one embodiment of the invention.

FIG. 3 schematically shows a profile view of a luminous device according to one embodiment of the invention.

FIG. 4 schematically shows a view from above of a luminous device and of part of a light beam according to one embodiment of the invention.

FIG. 5 schematically shows a view from above of a luminous device and of part of a light beam according to one embodiment of the invention.

Throughout the following description, elements that are identical in terms of structure or function and that appear in various figures have been designated by the same reference signs, unless otherwise specified.

### DETAILED DESCRIPTION OF INVENTION

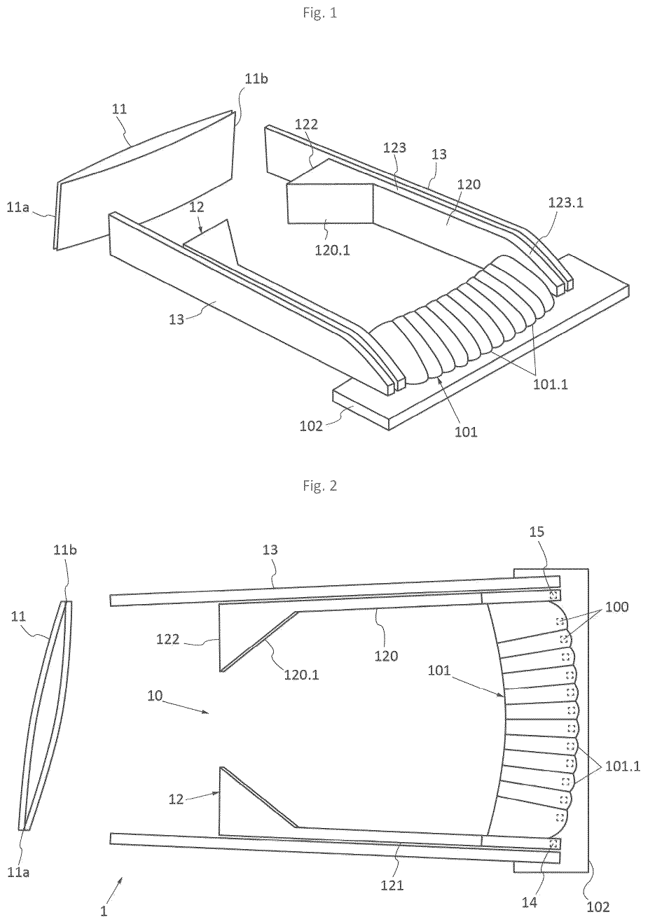

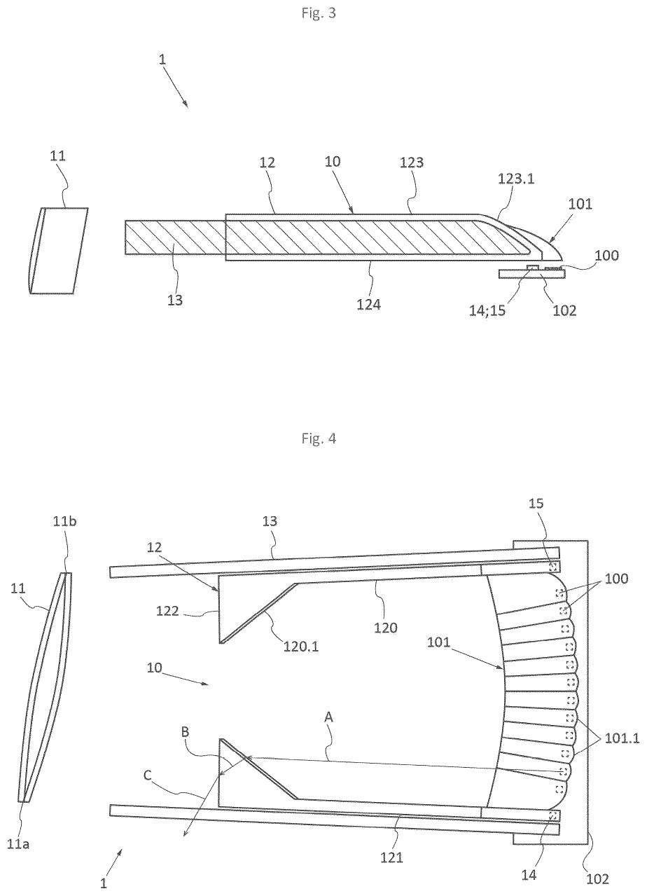

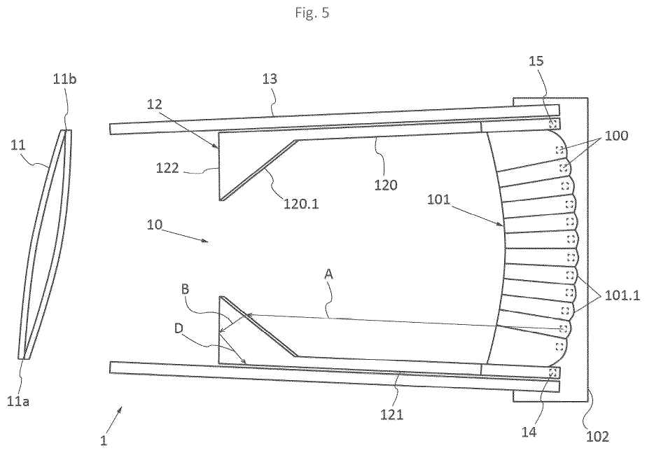

FIG. 1 shows a luminous device 1 of an automotive vehicle according to one particular embodiment of the invention. This luminous device 1 is described with reference to FIG. 2 and FIG. 3. The deflection of part of a light beam generated by the luminous device 1 is described with reference to FIG. 4 and FIG. 5.

The luminous device 1 of an automotive vehicle illustrated in FIG. 1 and FIG. 2 comprises a luminous module 10 comprising a plurality of first light sources 100 able to emit light and a collector 101 comprising twelve portions 101.1, each portion being associated with one of the first light sources 100. Each portion 101.1 of the collector 101 comprises a reflective surface arranged to collect and reflect the light emitted by said first light source 100 associated therewith, into an elementary light beam. All the elementary light beams reflected by each portion 101.1 of the collector 101 together form a light beam.

The luminous device 1 comprises a lens 11 associated with the luminous module 10. The lens 11 is arranged so that each portion 101.1 of the collector 101 reflects the elementary light beam in an elementary reflection direction passing through said lens 11. The lens 11 is arranged to project the light beam reflected by the collector 101 of the luminous module 10. The lens 11 is arranged to form on the road an image of the reflective surface of each portion 101.1 of the collector 101.

In particular, the lens 11 has a focal plane passing through a rear edge of the portions 101.1 of the collector 101, i.e. located at a distance less than 10 mm from a rear edge of the portions 101.1 of the collector 101.

The lens 11 comprises a first end 11a and a second end 11b forming lateral end zones of said lens 11.

The luminous device 1 has an optical axis defined by the overall direction of projection of the light beam by the lens 11.

A portion of the light beam is capable of reaching one of the ends 11a, 11b of the lens 11, this portion being said to be stray. The stray portion of the light beam comprises stray light rays A capable of being projected by one of the lateral end zones of the lens 11.

The luminous device 1 comprises two transparent diaphragms 12 placed between the collector 101 and the lens 11, along an optical path of the light beam. The two diaphragms 12 are placed on either side of the collector 101. The two diaphragms 12 are symmetrical. Each diaphragm 12 comprises an inner lateral surface 120 forming an inner side of each diaphragm 12. The inner lateral surface 120 is oriented toward the interior of the luminous module 10 and is located beside a lateral edge of the collector 101. Each diaphragm 12 comprises an outer lateral surface 121 forming an outer side of each diaphragm 12. The outer lateral surface 121, which lies opposite the inner lateral surface 120, is oriented toward the exterior of the luminous module 10. The outer lateral surface 121 is planar.

The inner lateral surface 120 of each diaphragm 12 comprises an incidence face 120.1 making an angle to the rest of said inner lateral surface 120. In the described embodiment, the incidence face 120.1 makes a salient angle to the rest of said inner lateral surface 120. The outer lateral surface 121 and inner lateral surface 120, with the exception of the incidence face 120.1 of said inner lateral surface 120, may be substantially parallel to each other.

Each diaphragm 12 comprises a deflection face 122 facing the incidence face 120.1. The incidence face 120.1 and the deflection face 122 may form a prism, said prism in particular possibly defining a distal portion of each diaphragm 12. The deflection face 122 forms a distal lateral surface connecting the inner lateral surface 120 and the outer lateral surface 120. The exit face of each diaphragm 12, which face is arranged facing the lens, coincides with the deflection face 122.

The incidence face 120.1 is configured to receive the stray portion A of the light beam reflected by the collector 101 of the luminous module 10 and arranged to refract said received stray portion A in a direction deviating from the lens 11, i.e. in a direction other than that of the optical path of the light beam.

The deflection face 122 is arranged so that the stray portion B refracted by the incidence face 120.1 is refracted C or reflected D by the deflection face 122. The two diaphragms 12 are placed so that the stray portion A of the light beam received by the incidence face 120.1 of one of the diaphragms 12 deviates in a direction opposite to the direction of the stray portion A of the light beam received by the incidence face 120.1 of the other of the diaphragms 12.

Each diaphragm 12 is intended to receive part of the light beam, in particular the stray portion A of said beam.

The diaphragm 12 comprises a lower surface 124 comprising the entrance face of the diaphragm 12. The diaphragm 12 comprises an upper surface 123 having a coupling face 123.1 arranged to deflect the light.

The luminous module 10 comprises a second light source 14 positioned facing the entrance face of one of the diaphragms 12 so as to emit light into said diaphragm 12, which light propagates by total internal reflection off the internal walls of said diaphragm 12 to its exit face. The luminous module 10 comprises a third light source 15 positioned facing the entrance face of the other of the diaphragms 12 so as to emit light into said diaphragm 12, which light propagates by total internal reflection off the internal walls of said diaphragm 12 to its exit face.

The coupling face 123.1 has a parabolic profile focused on the second light source 14 or on the third light source 15.

The luminous device 1 comprises a control unit (not shown) allowing the first light sources 100 to be selectively activated. The control unit is arranged to activate all of the plurality of first light sources 100.

The control unit of the luminous device 1 is arranged to simultaneously activate the second light source 14 with the first light sources 100. The second light source 14 emits light with a lower intensity than the first light sources 100.

The control unit of the luminous device 1 is arranged to simultaneously activate the third light source 15 with the first light sources 100. The control unit of the luminous device 1 is arranged to simultaneously activate the third light source 15 with the second light source 14. The third light source 15 emits light with a lower intensity than the first light sources 100 and an intensity similar to that of the second light source 14.

The luminous module 10 comprises a printed circuit board 102. The plurality of first light sources, the second light source 14 and the third light source 15 are mounted on the printed circuit board 102. The collector 101 and the two diaphragms 12 are mounted on the printed circuit board 102.

The luminous module 10 comprises two absorbers 13, each associated with one diaphragm 12 so as to absorb the stray portion refracted B and/or reflected D and/or re-refracted C by said diaphragm 12. Each absorber 13 is placed against the planar outer lateral surface of the diaphragm 12 with which it is associated.

As illustrated in FIG. 4 and FIG. 5, the elementary light beams emitted by the first light sources 100 are reflected by the collector 101 to form the light beam. Each of the stray portions A of the light beam is directed onto the incidence face 120.1 of the corresponding diaphragm 12. The incidence face is configured to refract the light rays of the stray portion A, in a refracted stray portion B, in the direction of the deflection face 122 of the diaphragm 12. The deflection face 122 is arranged to deflect the refracted stray portion B in a deflection direction that deviates more from the elementary re tion direction A than the refraction direction B. The deflection face 122 deflects the ref stray portion B into a reflected stray portion D or into a re-refracted stray portion C. The reflected stray portion D is deflected behind the prism. The re-refracted stray portion C is deflected in front of the prism.

The angle made between the optical axis and the elementary reflection direction A is smaller than the angle made between the optical axis and the refraction direction B, which itself is smaller than the angle made between the optical axis and the deflection direction C, D.

The preceding description clearly explains how the invention achieves its set objectives, namely to obtain a luminous device in which geometric aberrations in the projected beam are limited while allowing a lens having a uniform illuminated appearance and compact dimensions to be obtained, by providing a luminous device comprising a luminous module, and two transparent or translucent diaphragms configured to deflect stray light rays emitted by said luminous module.

In any event, the invention is not limited to the embodiments specifically described in this document, and particularly extends to all equivalent means and to any technically operative combination of these means. In particular, it may be envisioned for
the luminous device 1 to comprise a plurality of luminous modules 10;
the luminous module 10 to comprise a collector 101 comprising a single portion 101.1 associated with a light source 100;
the luminous module 10 to comprise a collector 101 comprising a single portion 101.1 associated with a plurality of light sources 100;
the diaphragm 12 to be translucent;
the inner lateral surface 120 to be in proximity to the lateral edge of the collector 101;
the incidence face 120.1 to make a re-entrant angle;
the coupling face 123.1 to have a parabolic profile focused on an entrance point of the entrance face of the diaphragm 12;
the coupling face 123.1 to have an elliptical profile;
the control unit to activate only some of the plurality of first light sources;
the second light source 14 to emit light with an intensity similar to the first light sources 100;
the third light source 15 to emit light with an intensity similar to the first light sources 100.

What is claimed is:

1. A luminous device of an automotive vehicle, comprising:
a. at least one luminous module, with the at least one luminous module including a plurality of first light sources able to emit light and at least one collector including a reflective surface arranged to collect and reflect the light emitted by the plurality of first light sources into a light beam;
b. a lens associated with the luminous module, arranged to project the light beam reflected by the collector of the luminous module, the lens being arranged to form on the road an image of the reflective surface of the collector of the luminous module;
c. at least one transparent or translucent diaphragm having an incidence face capable of receiving part of the light beam reflected by the collector of the luminous module and arranged to refract the received part in a direction deviating from the lens.

2. The luminous device as claimed in claim 1, wherein each of the plurality of first light sources is able to emit an elementary light beam, wherein the collector includes a plurality of portions, the reflective surface of each portion being arranged to reflect one of the elementary light beams in an elementary reflection direction passing through the lens, wherein a portion, called a stray portion, of at least one of the light beams is capable of reaching a lateral end zone of the lens, and wherein the incidence surface of the diaphragm is arranged to intercept the stray portion so as to refract it in a refraction direction deviating laterally from the elementary reflection direction and from the lateral end zone of the lens-CH.

3. The luminous device as claimed in claim 2, wherein the diaphragm includes a deflection face facing the incidence fac and arranged to deflect the stray portion refracted by the incidence face in a deflection direction deviating more from the elementary reflection direction than the refraction direction.

4. The luminous device as claimed in claim 3, wherein the incidence face and deflection face are arranged so that the refracted stray portion is refracted or reflected by the deflection face.

5. The luminous devis as claimed in claim 1, wherein the diaphragm has an inner lateral surface including the incidence face and extending from a lateral edge of the collector to the incidence face, the incidence face making an angle to the rest of the inner lateral surface.

6. The luminous device as claimed in claim 2, wherein the luminous module includes an absorber arranged to absorb the refracted stray portion.

7. The luminous device as claimed in claim 6, wherein the diaphragm has an outer lateral surface opposite the inner lateral surface, the absorber being arranged plumb with the outer lateral surface.

8. The luminous device as claimed in claim 1, wherein the luminous module includes two transparent or translucent diaphragms, arranged on either side of the collector and each having an incidence face capable of receiving part of the light beam reflected by the collector of the luminous module and arranged to refract the received part in a direction deviating from the lens.

9. The luminous device as claimed in claim 1, wherein luminous module includes a second light source positioned facing an entrance face of the and able to emit light into the diaphragm, the diaphragm being arranged so that the light emitted by the second light source propagates, by total internal reflection off the internal walls of the diaphragm, to an exit face of the diaphragm, with the exit being arranged facing the lens of the luminous module.

10. The luminous device as claimed in claim 9, wherein the diaphragm has a lower surface including the entrance face and an upper surface having a coupling face arranged to deflect and couple the light emitted by the second light source into the diaphragm.

11. The luminous device as claimed in claim 10, wherein the plurality of first light sources and the second light source are mounted on the same carrier.
